(19) United States
(12) Patent Application Publication
(10) Pub. No.: US 2007/0097423 A1
(43) Pub. Date: May 3, 2007

(54) Distributed printing controlling system, distributed printing controlling method, and program

(75) Inventor: Shinichi Kawano, Yamato-Koriyama-shi (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/525,742

(22) Filed: Sep. 22, 2006

(30) Foreign Application Priority Data
Oct. 27, 2005 (JP) 2005-312841

(51) Int. Cl. G06F 3/12

(52) U.S. Cl. 358/1.15

(57) ABSTRACT

A distributed printing controlling system and a distributed printing controlling method are provided that can easily execute the optimal distributed printing based on history information on what type of distributed printing was executed in the past when distributed printing is executed using a plurality of printing apparatuses. A distributed printing controlling system that is configured to connect a plurality of printing apparatuses through a network, to receive data transmitted from an information processing apparatus of a client, and to cause the plurality of printing apparatuses to distributed-print, the system including a storage unit that stores history information on distributed printing and a controlling unit that extracts distributed printing information based on the history information and sets and controls the distributed printing. The above history information can be history information on each document, history information on each user, or history information on printing settings.

### CROSS-NOTING PARAGRAPH

This Non-provisional application claims priority under 35 U.S.C. §119 (a) on Patent Application No. 2005-312841 filed in Japan on Oct. 27, 2005, the entire contents of which are hereby incorporated herein by reference.

### FIELD OF THE INVENTION

The present invention relates to a distributed printing controlling system, that is a system that distributes and executes printing using a plurality of printing apparatuses, and that makes settings for the printing and settings of printers that are destinations of distribution, and a distributed printing controlling method and a program therefor.

### BACKGROUND OF THE INVENTION

Conventionally, a distributed printing technique is known that divides pages or copies and executes printing using a plurality of printing apparatuses for a large number of pages or a large number of copies of one document. As to the distributed printing technique, for example, Japanese Laid-Open Patent Publication No. H11-194911 discloses a system (hereinafter, referred to as “printing server system”) that shares a high-performance printing apparatus connected with a server from an information processing apparatus (hereinafter, referred to as “terminal”) such as a personal computer through a LAN cable. Japanese Laid-Open Patent Publication No. H11-194911 discloses that the time for outputting printing data taken by each printing apparatus is calculated based on printing performance data for each printing apparatus that is a candidate to be assigned a predefined distributed task to and, thereby, dividing of the printing data is optimized to make the completion of printing by each printing apparatus be at the same time, the divided printing data are assigned respectively to printing apparatuses and printing is instructed.

Japanese Laid-Open Patent Publication No. 2002-149361 discloses a method of printing under excellent printing conditions even without specific knowledge concerning printers and printing processes by advising a user on the optimal printing conditions by detecting biases of the printing conditions based on past printing conditions such as color, monochrome, double-sided printing setting, N-up setting for one multi-functional apparatus in a printing process (more specifically, a process in a printer driver) in a printing data processing system.

However, to execute distributed printing using a plurality of printing apparatuses, according to the technique described in Japanese Laid-Open Patent Publication No. H11-194911, though a large number of pages can be printed at a high speed, a problem has arisen that operations such as making printing settings are difficult and uniform printing results are difficult to obtain in distributed printing using a plurality of multi-functional apparatuses respectively having different functions such as integrated fonts and color/monochrome. According to the technique described in Japanese Laid-Open Patent Publication No. 2002-149361, though operativity is excellent because advice on printing settings is given, the technique can not be used in distributed printing for a plurality of multi-functional apparatuses respectively having different functions because the printing settings are for one multi-functional apparatus.

### SUMMARY OF THE INVENTION

An object of the present invention is to provide a distributed printing controlling system and a distributed printing controlling method that can easily execute the optimal distributed printing based on history information on what type of distributed printing was executed in the past when distributed printing is executed using a plurality of printing apparatuses.

Another object of the present invention is to provide a distributed printing controlling system that is configured to connect a plurality of printing apparatuses through a network, receive data transmitted from an information processing apparatus of a client, and cause the plurality of printing apparatuses to print in a distributed manner, the system including a storage unit that stores history information on distributed printing and a controlling unit that extracts distributed printing information based on the history information and sets and controls the distributed printing using the extracted information.

The above history information can be, for example, history information on each document, history information on each user, or history information on printing settings. The above distributed printing information can be, for example, information on printers to be distribution destinations or information on printing settings. The extracted distributed printing information is displayed by a displaying apparatus and the distributed printing settings can be set automatically. The printing result for an image output apparatus is kept stored as history information for the future with history indicating success or failure inputted.

### BRIEF DESCRIPTION OF THE DRAWINGS

FIG. 1 is a schematic view of the configuration of a distributed printing controlling system according to the present invention;

FIG. 2 is an explanatory schematic block diagram of the configuration of a server terminal that executes distributed printing control of the present invention;

FIG. 3 is an explanatory schematic block diagram of the configuration of a client terminal that executes distributed printing control of the present invention;

FIG. 4 is an explanatory view of an example of history information according to the present invention;

FIG. 5 shows an example of a user interface of a message presented to a user for the printing result of the distributed printing;

FIG. 6 is an explanatory view of an example of an execution flow of the distributed printing (history for the same document) according to the present invention;

FIGS. 7A to 7C show examples of the user interface of messages used in the execution flow of FIG. 6;

FIG. 8 is an explanatory view of an example of the execution flow of the distributed printing (history for the same user) according to the present invention;

FIGS. 9A to 9C show examples of the user interface of messages used in the execution flow of FIG. 8;

FIG. 10 is an explanatory view of an example of the execution flow of the distributed printing (history for the same printing settings) according to the present invention; and

FIGS. 11A to 11C show examples of the user interface of messages used in the execution flow of FIG. 10.

### PREFERRED EMBODIMENTS OF THE INVENTION

The present invention lies in executing the optimal distributed printing referring to printing settings employed when distributed printing of a document was executed in the past such as, for example, information such as fonts, color/monochrome, and single-sided/double-sided and information such as information as to which printers were used when the distributed printing is executed using a plurality of printing apparatuses. In this case, various embodiments can be listed such as those concerning whether a document to be printed in the distributed manner is the same document as the document that was printed in the distributed manner in the past, which a user of the distributed printing (client terminal) is, or whether printing was executed with similar settings in the past when distributed printing settings are made.

In any of the above embodiments, proper advice is presented to a user based on the history information of the distributed printing, the optimal distributed printing is enabled and the distributed printing is enabled using the automatic printing settings in the history information. When distributed printing is executed, by adding the printing result as an additional piece of the history information or updating the history information using the printing result, further distributed printing is enabled to be executed in a more optimal form.

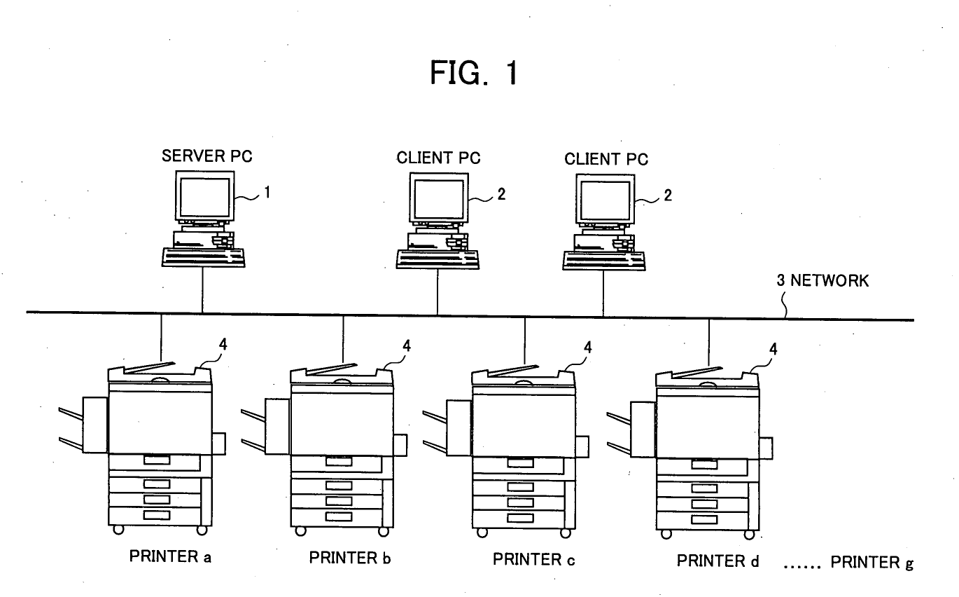

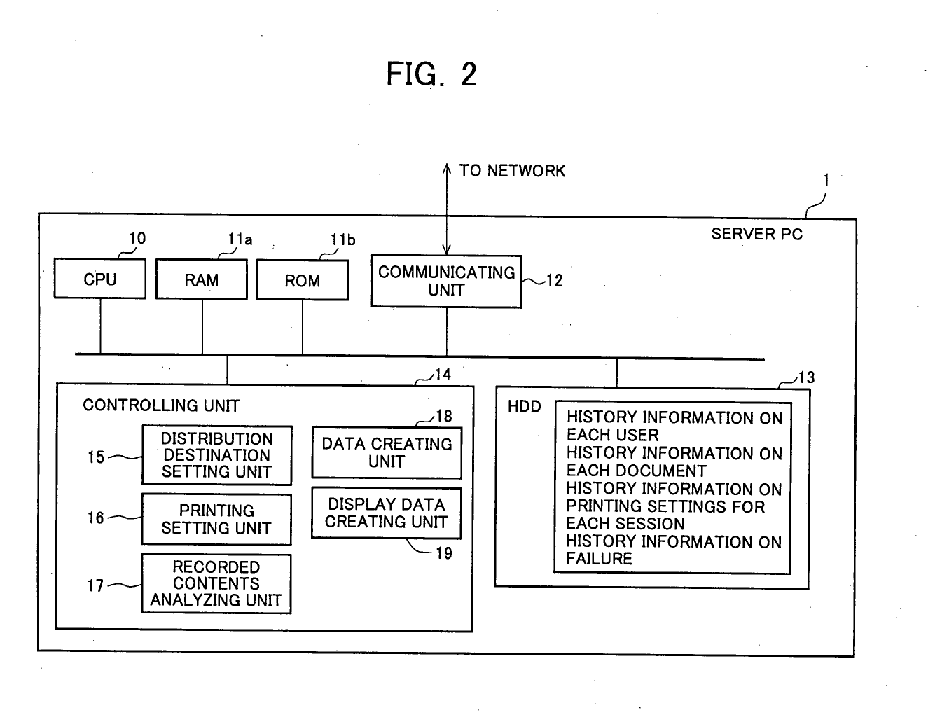

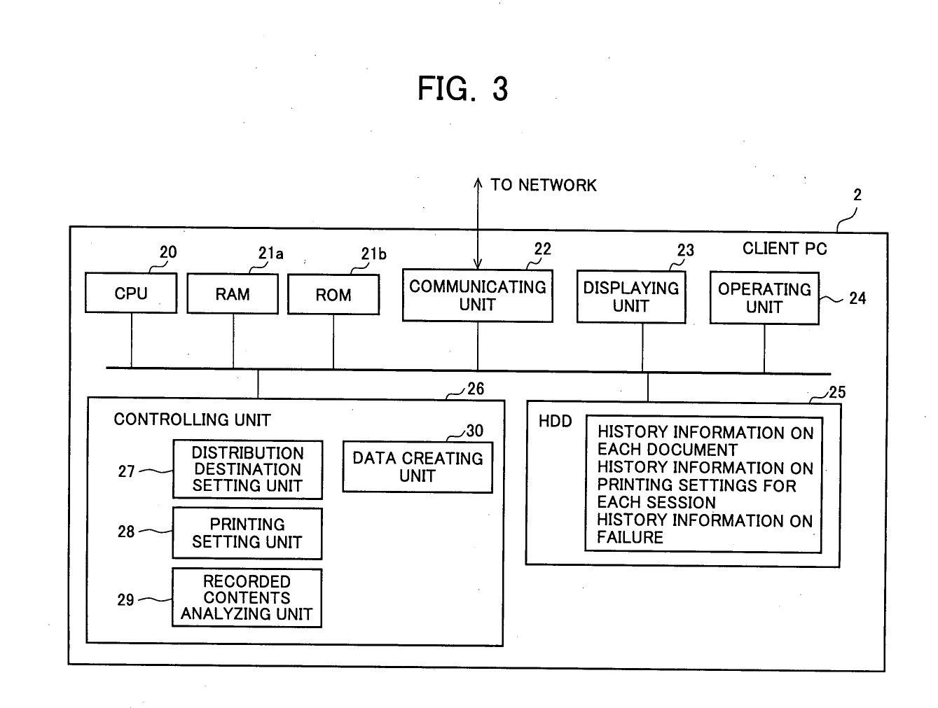

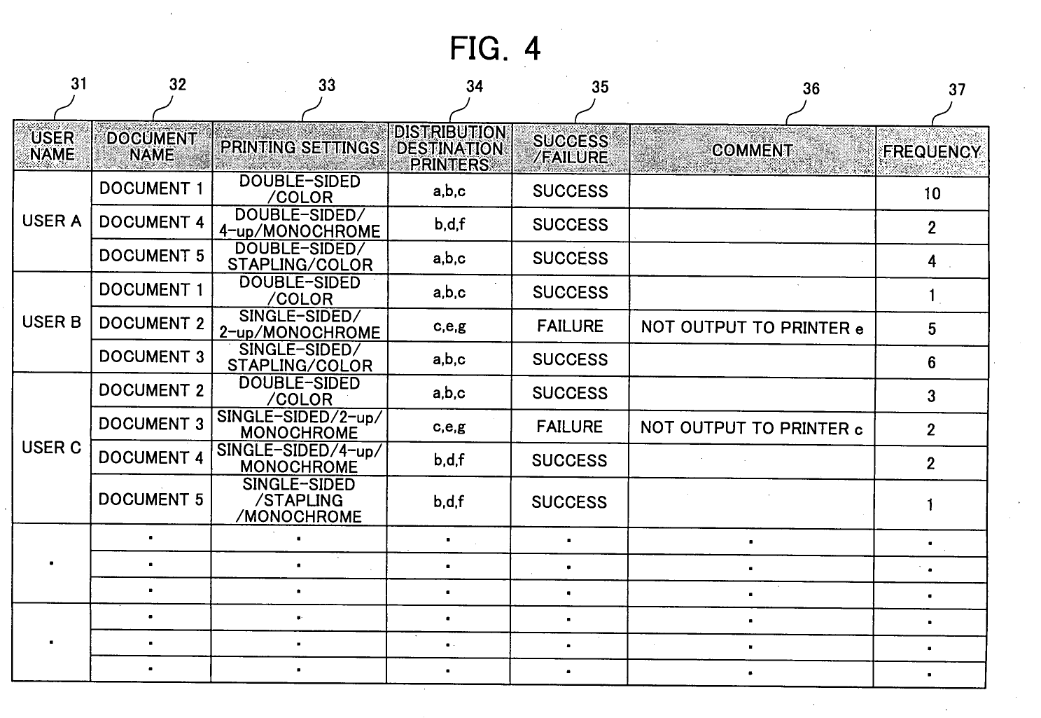

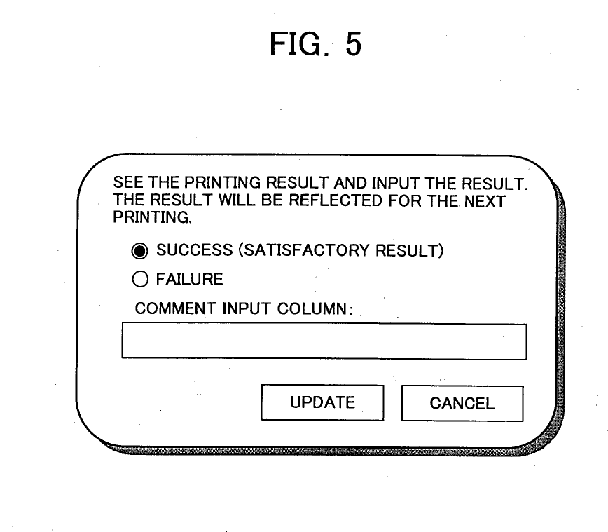

An embodiment of the present invention will be described referring to the drawings. FIG. 1 is a schematic view of the configuration of a distributed printing controlling system according to the present invention. FIG. 2 is a schematic block diagram of the configuration of an information processing apparatus (server terminal) that executes distributed printing control of the present invention. FIG. 3 is a schematic block diagram of the configuration of an information processing apparatus (client terminal) that executes distributed printing control of the present invention. FIG. 4 is an explanatory view of an example of history information according to the present invention. FIG. 5 shows an example of a user interface of a message presented to a user for the printing result of the distributed printing.

As shown in FIG. 1, the distributed printing control system according to the present invention is configured to connect communicably a plurality of printing apparatuses (printers) 4 that are examples of image output apparatuses, a server terminal (personal computer: PC) 1 that is an example of an information processing apparatus, and a plurality of client terminals (PCs) 2 through a predetermined network 3 complying with, for example, IEEE 802.3.

In the distributed printing controlling system, for example, printing data is sent from the client PC 2 to the server PC 1 and a printing job is transmitted being distributed from the server PC 1 to the plurality of printers 4 through the network 3. A document corresponding to the printing job is printed (outputted) on recording paper sheets by the plurality of printers 4 that have received the job. Otherwise, the printing job is directly created from an application of the client PC 2 and transmitted being distributed to the plurality of printers 4 through the network 3, and the printing job is printed by the plurality of printers 4 that have received the printing job.

FIG. 2 is a schematic block diagram of the configuration of the server PC 1 of the present invention and the distributed printing controlling system of the present invention will be schematically described referring to the block diagram.

As shown, the server PC 1 includes a CPU 10 that executes various types of calculation, a RAM 11a that stores a program developed therein that is executed by the CPU 10, and a ROM 11b that stores programs that are executed by the CPU 10 such as BIOS. The server PC 1 also includes a communicating unit 12 that executes data communication through the network 3, receives data created by an application of the plurality of client PCs 2, and transmits a printing job to the plurality of printers 4.

The distributed printing controlling system according to the present invention includes a storage unit 13 such as a hard disk drive (HDD) that stores the history information on the past in addition to storing various types of driver software, application programs, and various types of data and also includes a controlling unit 14 that sets and controls distributed printing by extracting the history information for the past from the storage unit 13. The controlling unit 14 consists of, for example, a distribution destination setting unit 15 that sets the distribution destinations of printing, a printing setting unit 16 that sets single-sided/double-sided, N-up, color/monochrome, etc., a recorded contents analyzing unit 17 that analyzes the history information of the past distributed printing stored in the storage unit 13, a data creating unit 18 that creates printing data from the data from the plurality of client PCs 2, and a display data creating unit 19 that creates data to be displayed by the client PCs 2.

FIG. 3 is a schematic block diagram of the configuration of the client PC 2 to execute distributed printing directly from the client PC 2 and not through the server PC 1. The client PC 2 is configured to execute the same function as that of the server PC 1 described above. That is, similarly to the server PC 1, the client PC 2 includes a CPU 20 that executes various types of calculation, a RAM 21a that stores a program developed therein that is executed by the CPU 20, and a ROM 21b that stores programs that are executed by the CPU 20 such as BIOS. The client PC 2 also includes a communicating unit 22 that transmits printing data created from the application, a displaying unit 23 such as a liquid crystal panel, a CRT, etc., and an operating unit 24 such as a keyboard, a mouse, etc.

The client PC 2 of FIG. 3 also includes a storage unit 25 such as a hard disk drive (HDD) that stores the history information for the past in addition to storing various types of driver software, application programs, and various types of data, and a controlling unit 26 that sets and controls distributed printing by extracting the history information on the past from the storage unit 25. The controlling unit 26 consists of, for example, a distribution destination setting unit 27 that sets the distribution destinations of printing, a printing setting unit 28 that sets single-sided/double-sided, N-up, color/monochrome, etc., a recorded contents analyzing unit 29 that analyzes the history information of the past distributed printing stored in the storage unit 25, and a data creating unit 30 that creates printing data from the application.

By including the configuration concerning the above distributed printing control, various types of history information on distributed printing can be stored in the storage unit 13 or 25 and, when distributed printing is executed newly, the distributed printing can be controlled referring to the history information by the controlling unit 14 or 26. As a result, a user does not need to provide his/her labor for or pay attention to the settings of distributed printing when history information with which distributed printing was executed before is present, and the user can execute appropriate distributed printing without specific knowledge concerning distributed printing.

FIG. 4 shows an example of the history information stored in the storage unit 13 of the server PC 1 of FIG. 2 and the storage unit 13 stores items such as “user name” 31, “document name” 32, “printing settings” 33, “distribution destination printers” 34, “success/failure” 35, “comment” 36, “frequency” 37.

The user name 31 facilitates identification of past history information by searching names in the user name 31 or names in the document name 32 as to who used the printing (or used a client terminal). When the same user used, settings suitable for the taste of the user can be made such as the user's policy for fonts and colors and use of a nearby printer by having caused history information to be stored for each user name.

The document name 32 makes the user know the type of a document. When a same document is printed in a distributed manner, by storing the history information for each document name, specific printing settings such as double-sided/N-up/color can be easily set without paying much attention and without specific knowledge concerning the printer or a printing process.

The item, the printing settings 33 stores as to what settings a document was printed with in the past such as single-sided/double-sided, N-up, color/monochrome, with/without stapling. With the past settings remaining as history information, inquiry about the performance of a printer that is suitable for the setting, etc., by executing broadcasting is not necessary even when printing settings are newly made.

The item, distribution destination printer 34 shows which printers were used in the past distributed printing sessions. Though the printing performance differs by printer, settings of the distribution destination printers can be made without paying attention to the performance of the distribution destination printers, etc., when the distributed printing information remains as the history information.

In the present invention, among the pieces of history information, the pieces of information for the above printing settings 33 and the distribution destination printer 34 are collectively referred to as “distributed printing information” and, when distributed printing is executed, settings can be made without confusion even in changing the settings by referring to the history information.

The item, success/failure 35 of printing information shows whether the printing result of distributed printing in the past was satisfactory (success) or unsatisfactory (failure) and, when the result was failure, reference information of countermeasures against the failure is displayed as a comment in the comment 36. As to “success/failure” and “comment” therefor, for example, unevenness of colors and difference in appearance of fonts, etc., are inputted using a message shown in FIG. 5 based on visual judgment of the user. When any unsatisfactory distributed printing sessions are present in the past distributed printing sessions, unsatisfactory printing can be avoided in the next distributed printing session.

The item, frequency 37 shows how many times distributed printing for the same user and the same document was executed in the past.

FIG. 5 is a user interface that is displayed by the displaying unit 23 of the client PC 2 and inputted by the operating unit 24, and is displayed when distributed printing has finished and is inputted by the user. Though the input is based on the user's visual judgment, the interface can be automatically inputted into by setting judgment criteria for success/failure.

As the example of FIG. 3, when printing is directly instructed from the client PC 2, document name 32, printing settings 33, distribution destination printer 34, success/failure 35, comment 36, and frequency 37 are stored excluding user name 31 from the history information shown in FIG. 4 as the history information in the storage unit 25 of the above client PC 2. In the case where the printing is directly instructed from the client PC 2 without passing through the server, distributed printing can be executed at a higher speed than that of the case where the server is passed through and, more excellent distributed printing can be executed in printing executed when the server PC 1 is congested.

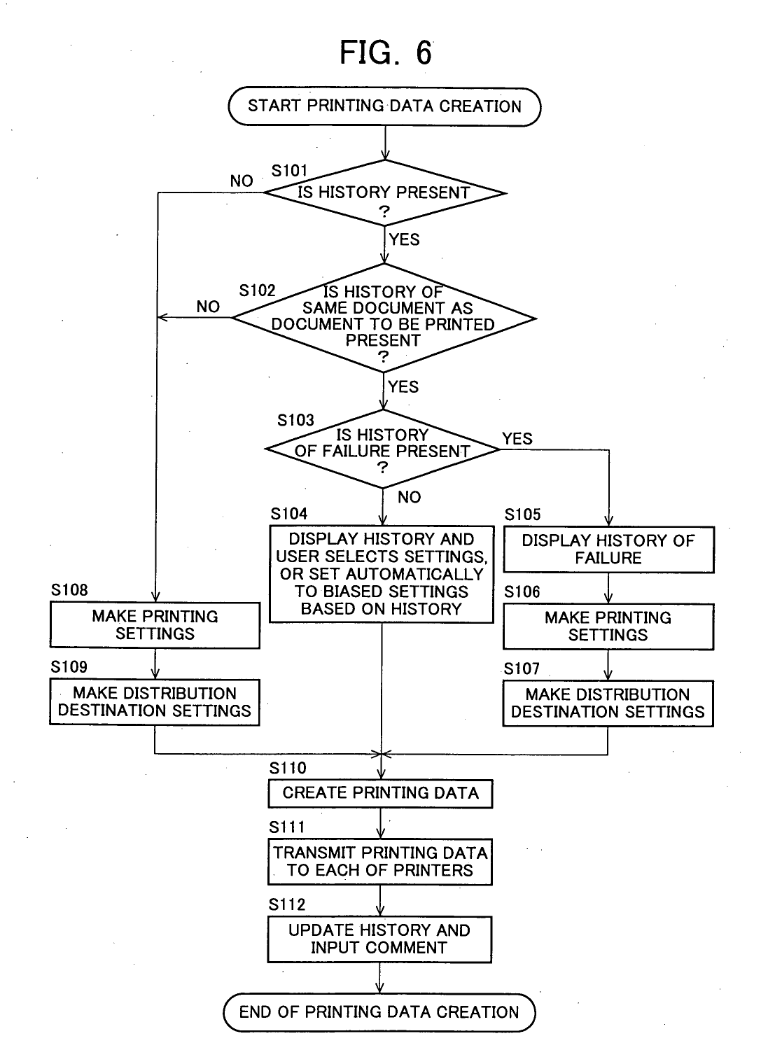

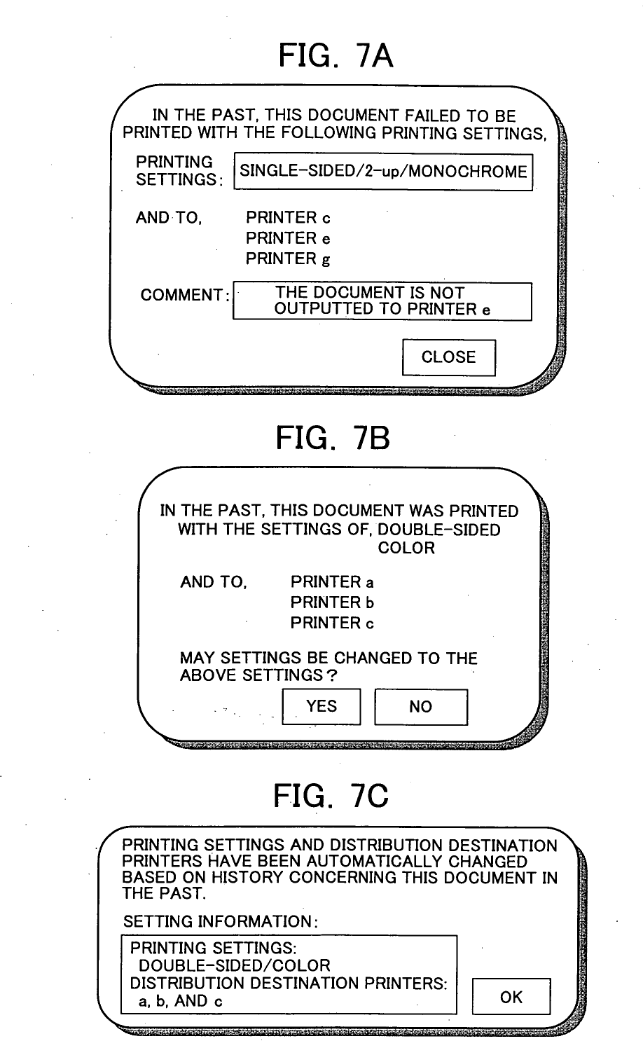

A procedure will be described that is taken when the history information is stored for each document and printing data is created by searching whether distributed printing was executed in the past for the same document referring to an execution flow of distributed printing shown in FIG. 6 and examples of user interfaces of messages to be displayed to give advice to the user of FIGS. 7A to 7C. In the description of the flow of FIG. 6, S101, S102, . . . denote the serial numbers of the process steps (steps) and the reference numerals of the functional units described referring to FIGS. 1 to 5 will be used.

A printing data creating process employed when printing data is transmitted from the client PC 2 to the server PC 1 will be described.

When printing data creation is started, whether any history stored in the storage unit (HDD) 13 is present is judged (step S101). When the history is present, the recorded contents analyzing unit 17 judges whether the history of the same document as the document of the transmitted printing data is present (step S102). When the history of the same document is present, the recorded contents analyzing unit 17 judges whether any history of failure is present (step S103). For example, for printing data creation concerning “a document 2 of a user B” shown in FIG. 4, history of failure is present and, therefore, the display data creating unit 19 of the server PC 1 creates a message as shown in FIG. 7A and causes the displaying unit 23 of the client PC 2 to display the message (step S105).

Based on the information, a user makes printing settings (step S106) and settings of distribution destination printers (step S107). Thereafter, the data creating unit 18 of the server PC 1 creates printing data (step S110) and transmits the printing data to each of the printers 4 through the communicating unit 12 based on the settings (step S111). The data creating unit 18 causes the displaying unit 23 of the client PC 2 to display a result input screen as in FIG. 5 and the printing result is inputted from the operating unit 24 (step S112). The process is ended.

As an example of the case where no history of failure is present at step S103 (NO), for example, no history of failure is present for printing data creation concerning “a document 1 of a user A and the user B” shown in FIG. 4. Therefore, the display data creating unit 19 of the server PC 1 creates a message as in FIG. 7B, causes the displaying unit 23 of the client PC 2 to display the message, and makes printing settings and sets the distribution destination printers. In this case, the printing settings and the distribution destination printers can be initially set automatically to settings of respectively “double-sided/color” and “a, b, and c” using the distribution destination setting unit 15 and the printing setting unit 16 based on the history information. The display data creating unit 19 of the server PC 1 creates a message as in FIG. 7C and causes the displaying unit 23 of the client PC 2 to display the message (step S104).

After such settings are made, the data creating unit 18 of the server PC 1 creates printing data (step S110) and transmits the printing data to each of the printers 4 through the communicating unit 12 based on the settings (step S111). The data creating unit 18 causes the displaying unit 23 of the client PC 2 to display a result input screen as in FIG. 5 and the result is inputted from the operating unit 24 to update the history (step S112). The process is ended.

When no history is present at steps S101 (NO) and S102 (NO), the user makes printing settings (step S108) and makes settings of the distribution destination printers (step S109) using the printing setting unit 28 and the distribution destination setting unit 27 of the client PC 2. The data creating unit 18 of the server PC 1 creates printing data (step S110) and transmits the printing data to each of the printers 4 (step S111) through the communicating unit 12 based on the settings. Similarly to the above, the data creating unit 18 causes the displaying unit 23 of the client PC 2 to display a result input screen as in FIG. 5 and the result is inputted from the operating unit 24 to reflect the result on the next printing (step S112). The process is ended.

A printing data creating process will be described for the case where the distributed printing is directly executed according to an instruction from the client PC 2 without passing through the server PC 1. The flowchart thereof itself is same as that for the case with the server PC 1 as above. However, the history shown in FIG. 4 is information that lacks the history concerning the item, “user name” because the user executes the process for the history on the client PC 2.

Similarly to the case using the server PC 1, whether history stored in the storage unit (HDD) 25 of the client PC 2 is present is judged (step S101). When the history is present, the recorded contents analyzing unit 29 judges whether the history of the same document as the document of the printing data is present (step S102). When the history of the same document is present, the recorded contents analyzing unit 29 judges whether any history of failure is present (step S103). For example, for printing data creation concerning “the document 2 of the user B” shown in FIG. 4, history of failure is present and, therefore, the displaying unit 23 of the client PC 2 is caused to display the message as shown in FIG. 7A (step S105).

Based on the information, a user makes printing settings (step S106) and settings of distribution destination printers (step S107). Thereafter, the data creating unit 30 of the client PC 2 creates printing data (step S110) and transmits the printing data to each of the printers 4 through the communicating unit 22 based on the settings (step S111). The data creating unit 30 causes the displaying unit 23 of the client PC 2 to display a result input screen as in FIG. 5 and the printing result is inputted from the operating unit 24 (step S112). The process is ended.

As an example of the case where no history of failure is present at step S103 (NO), for example, no history of failure is present for printing data creation concerning “the document 1 of the user A” shown in FIG. 4. Therefore, the displaying unit 23 of the client PC 2 is caused to display a message as shown in FIG. 7B, and printing settings are made and the distribution destination printers are set. In this case, the printing settings and the distribution destination printers can be automatically changed to settings of respectively “double-sided/color” and “a, b, and c” using the distribution destination setting unit 27 and the printing setting unit 28 based on the history information. The displaying unit 23 of the client PC 2 is caused to display a message as shown in FIG. 7C (step S104).

After such settings are made, the data creating unit 30 of the client PC 2 creates printing data (step S110) and transmits the printing data to each of the printers 4 through the communicating unit 22 based on the settings (step S111). The data creating unit 30 causes the displaying unit 23 of the client PC 2 to display a result input screen as in FIG. 5 and the result is inputted from the operating unit 24 to update the history (step S112). The process is ended.

When no history is present at steps S101 (NO) and S102 (NO), the user makes printing settings (step S108) and makes settings of the distribution destination printers (step S109) using the printing setting unit 28 and the distribution destination setting unit 27 of the client PC 2. The data creating unit 30 of the client PC 2 creates printing data (step S110) and transmits the printing data to each of the printers 4 (step S111) through the communicating unit 22 based on the settings. Similar to the above, the displaying unit 23 of the client PC 2 is caused to display a result input screen as in FIG. 5 and the result is inputted from the operating unit 24 to reflect the result on the next printing (step S112). The process is ended.

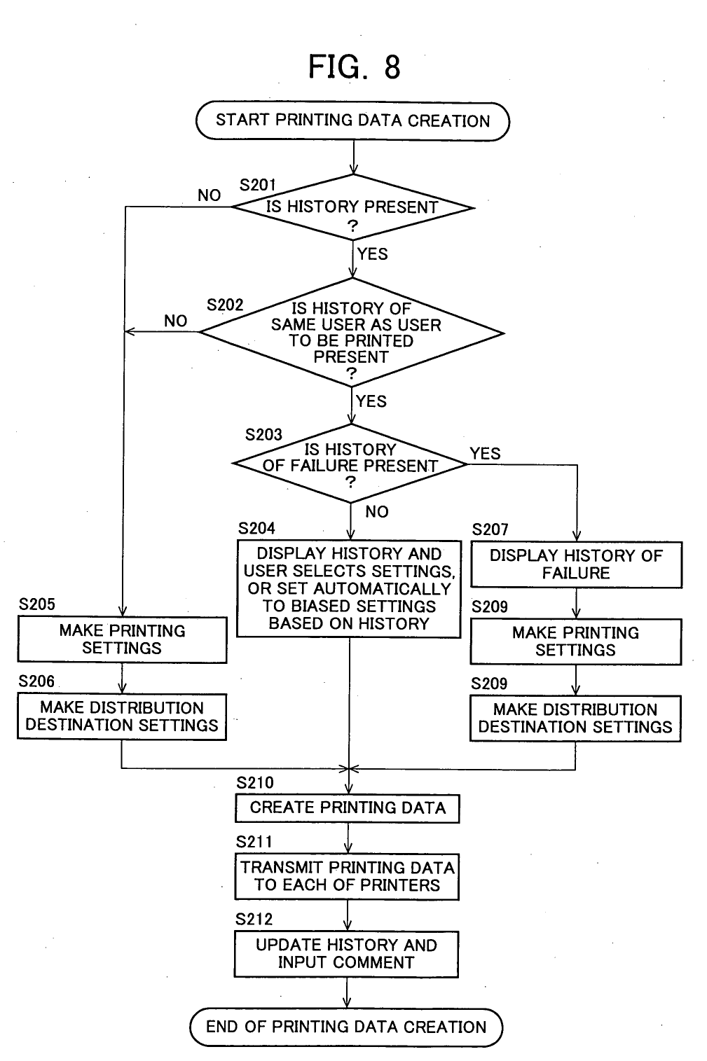

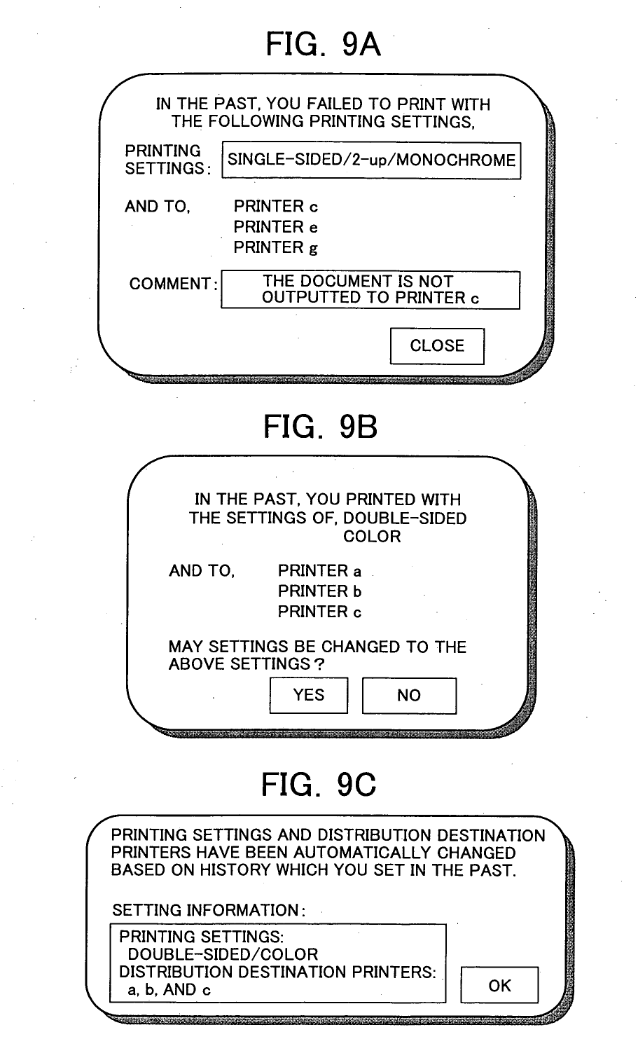

A procedure will be described that is taken when the history information is stored for each user and printing data is created by searching whether distributed printing was executed in the past for the same user referring to an execution flow of distributed printing shown in FIG. 8 and examples of user interfaces of messages to be displayed to give advice to the user of FIGS. 9A to 9C. In the description of the flow of FIG. 8, S201, S202, . . . denote the serial numbers of the process steps (steps) and the reference numerals of the functional units described referring to FIGS. 1 to 5 will be used.

A printing data creating process employed when printing data is transmitted from the client PC 2 to the server PC 1 will be described.

Whether any history stored in the storage unit (HDD) 13 is present is judged (step S201). When the history is present, the recorded contents analyzing unit 17 judges whether the history of the same user as the user of the transmitted printing data is present (step S202). When the history of the same user is present, the recorded contents analyzing unit 17 judges whether any history of failure of the same user is present (step S203). For example, when history of failure such as “a document 3 of a user C” shown in FIG. 4 is present, the display data creating unit 19 of the server PC 1 creates a message as shown in FIG. 9A and causes the displaying unit 23 of the client PC 2 to display the message (step S207).

Based on the information, a user makes printing settings (step S208) and settings of distribution destination printers (step S209). Thereafter, the data creating unit 18 of the server PC 1 creates printing data (step S210) and transmits the printing data to each of the printers 4 through the communicating unit 12 based on the settings (step S211). The data creating unit 18 causes the displaying unit 23 of the client PC 2 to display a result input screen as in FIG. 5 and the printing result is inputted from the operating unit 24 (step S212). The process is ended.

For example, the history of “the user A” shown in FIG. 4 is an example of the case where no history of failure is present at step S203 (NO), and history information (printing settings for the document 1) of the most frequent settings (bias) is present for printing data creation concerning “the user A”. As to the history-information, the display data creating unit 19 of the server PC 1 creates a message as in FIG. 9B, causes the displaying unit 23 of the client PC 2 to display the message, and makes printing settings and sets the distribution destination printers. In this case, the printing settings and the distribution destination printers can be automatically changed to settings of respectively “double-sided/color” and “a, b, and c” using the distribution destination setting unit 27 and the printing setting unit 28 of the client PC 2 based on the history information. The display data creating unit 19 of the server PC 1 creates a message as in FIG. 9C and causes the displaying unit 23 of the client PC 2 to display the message (step S204).

After such settings are made, the data creating unit 18 of the server PC 1 creates printing data (step S210) and transmits the printing data to each of the printers 4 through the communicating unit 12 based on the settings (step S211). The data creating unit 18 causes the displaying unit 23 of the client PC 2 to display a result input screen as in FIG. 5 and the result is inputted from the operating unit 24 to update the history (step S212). The process is ended.

When no history is present at steps S201 (NO) and S202 (NO), the user makes printing settings (step S205) and makes settings of the distribution destination printers (step S206) using the printing setting unit 28 and the distribution destination setting unit 27 of the client PC 2. The data creating unit 18 of the server PC 1 creates printing data (step S210) and transmits the printing data to each of the printers 4 (step S211) through the communicating unit 12 based on the settings. Similarly to the above, the data creating unit 18 causes the displaying unit 23 of the client PC 2 to display a result input screen as in FIG. 5 and the result is inputted from the operating unit 24 to reflect the result on the next printing (step S212). The process is ended.

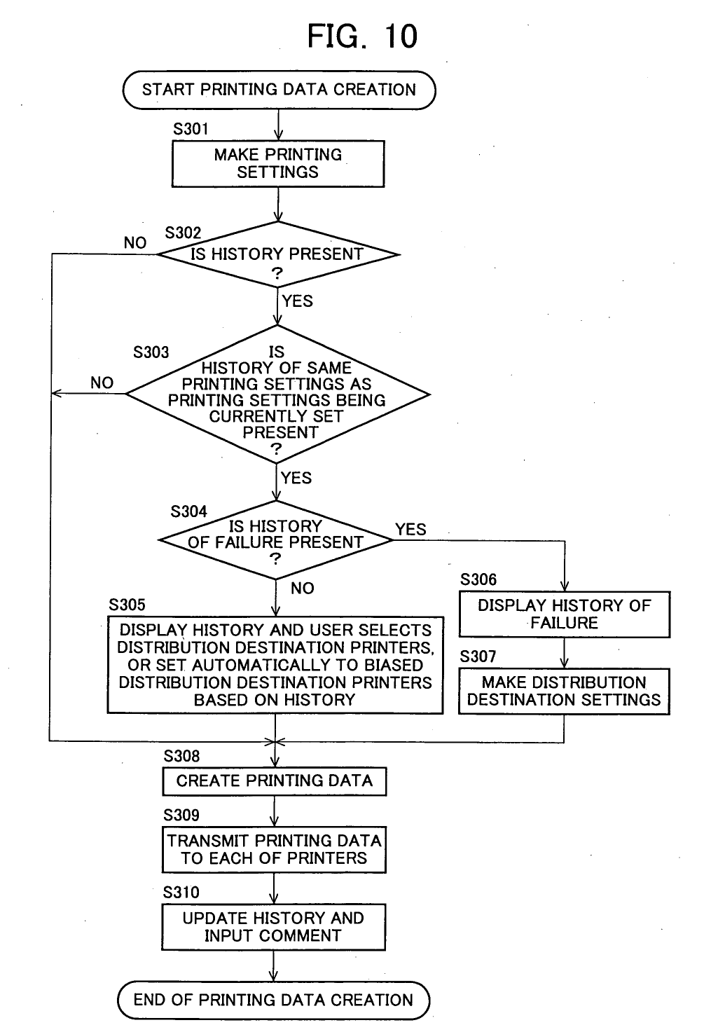

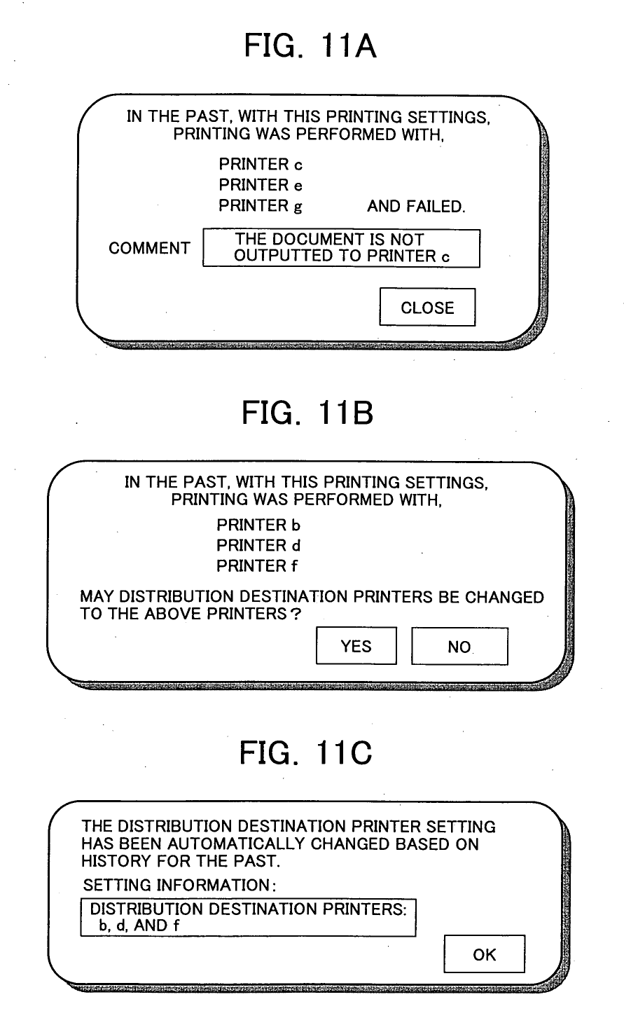

A procedure will be described that is taken when printing data is created by searching history information concerning printing settings as to whether distributed printing was executed in the past with the same printing settings referring to an execution flow of distributed printing shown in FIG. 10 and examples of user interfaces of messages to be displayed to give advice to the user of FIGS. 11A to 11C. In the description of the flow of FIG. 10, S301, S302, . . . denote the serial numbers of the process steps (steps) and the reference numerals of the functional units described referring to FIGS. 1 to 5 will be used.

A printing data creating process employed when printing data is transmitted from the client PC 2 to the server PC 1 will be described.

At the start, the printing setting unit 16 of the server PC 1 makes printing settings of, for example, “double-sided/2-up/monochrome” (step S301). Whether any history indicating that the above printing settings are stored in the storage unit (HDD) 13 is judged (step S302). When the history is present, the recorded contents analyzing unit 17 judges whether the history of the same printing settings as the printing settings currently being set is present (step S303). When the history of the same printing settings is present, the recorded contents analyzing unit 17 judges whether any history of failure is present (step S304).

When history of failure is present for settings of “single-sided/2-up/monochrome” as “the document 3 of the user C” shown in FIG. 4, the display data creating unit 19 of the server PC 1 creates a message as shown in FIG. 11A and causes the displaying unit 23 of the client PC 2 to display the message (step S306). Based on the information, a user makes settings of distribution destination printers (step S307) Thereafter, the data creating unit 18 of the server PC 1 creates printing data (step S308) and transmits the printing data to each of the printers 4 through the communicating unit 12 based on the settings (step S309). The data creating unit 18 causes the displaying unit 23 of the client PC 2 to display a result input screen as in FIG. 5 and the printing result is inputted from the operating unit 24 (step S310) The process is ended.

As an example of the case where no history of failure is present at step S304 (NO), settings of “double-sided/4-up/monochrome” are made at step S301. Because the settings are same as those of “a document 4 of the user A” of FIG. 4, the display data creating unit 19 of the server PC 1 creates a message as in FIG. 11B, causes the displaying unit 23 of the client PC 2 to display the message, and sets the distribution destination printers. In this case, the distribution destination printers can be automatically set to change the settings thereof to “b, d, and f” using the distribution destination setting unit 15 based on the history information. The display data creating unit 19 of the server PC 1 creates a message as in FIG. 11C and causes the displaying unit 23 of the client PC 2 to display the message (step S305).

After such settings are made, the data creating unit 18 of the server PC 1 creates printing data (step S308), transmits the printing data to each of the printers 4 through the communicating unit 12 based on the settings (step S309), and causes the displaying unit 23 of the client PC 2 to display a result input screen as in FIG. 5 and the result is inputted from the operating unit 24 (step S310). The process is ended.

When no history is present at steps S302 (NO) and S303 (NO), the data creating unit 18 of the server PC 1 creates printing data without any additional steps (step S308) and transmits the printing data to each of the printers 4 (step S309) through the communicating unit 12 based on the settings. Similarly to the above, the data creating unit 18 causes the displaying unit 23 of the client PC 2 to display a result input screen as in FIG. 5 and the result is inputted from the operating unit 24 (step S310). The process is ended.

A printing data creating process will be described for the case where the distributed printing is directly executed according to an instruction from the client PC 2 not through the server PC 1. The flowchart thereof itself is same as that for the case with the server PC 1 as above. However, the history shown in FIG. 4 is information that lacks the history concerning the item, “user name” because the user executes the process for the history on the client PC 2.

Similarly to the case with the server PC 1, the printing setting unit 28 of the client PC 2 makes printing settings such as, for example, “double-sided/2-up/monochrome” (step S301). Whether any history is present that indicates that the above printing settings are stored in the storage unit (HDD) 25 is judged (step S302). When the history is present, the recorded contents analyzing unit 29 judges whether any history of printing settings that are same as the printing settings currently being set is present (step S303). When history of failure is present in settings of “single-sided/2-up/monochrome” as “the document 3 of the user C” shown in FIG. 4, the displaying unit 23 is caused to display the message as shown in FIG. 11A (step S306).

Based on the information, a user changes settings of the distribution destination printers (step S307). Thereafter, the data creating unit 30 of the client PC 2 creates printing data (step S308) and transmits the printing data to each of the printers 4 through the communicating unit 22 based on the settings (step S309). The data creating unit 30 causes the displaying unit 23 of the client PC 2 to display a result input screen as in FIG. 5 and the printing result is inputted from the operating unit 24 (step S310). The process is ended.

As an example of the case where no history of failure is present at step S304 (NO), settings are made as “double-sided/4-up/monochrome” at step S301. The settings are same as the settings for “the document 4 of the user A” shown in FIG. 4. Therefore, the displaying unit 23 of the client PC 2 is caused to display a message as shown in FIG. 11B and the distribution destination printers are set. In this case, the distribution destination printer settings can be automatically changed to settings of “b, d, and f” using the distribution destination setting unit 27 based on the history information. The displaying unit 23 of the client PC 2 is caused to display a message as shown in FIG. 11C (step S305).

After such settings are made, the data creating unit 30 of the client PC 2 creates printing data (step S308) and transmits the printing data to each of the printers 4 through the communicating unit 22 based on the settings (step S309). The data creating unit 30 causes the displaying unit 23 of the client PC 2 to display a result input screen as in FIG. 5 and the result is inputted from the operating unit 24 (step S310). The process is ended.

When no history is present at steps S302 (NO) and S303 (NO), the data creating unit 30 of the client PC 2 creates printing data without any additional steps (step S308) and transmits the printing data to each of the printers 4 (step S309) through the communicating unit 22 based on the settings. Similar to the above, the data creating unit 30 causes the displaying unit 23 of the client PC 2 to display a result input screen as in FIG. 5 and the result is inputted from the operating unit 24 (step S310). The process is ended.

As above, according to the present invention, when distributed printing is executed, with history information being present that indicates that the distributed printing was substantially executed in the past, advice is given based on information indicating failure or success of the printing settings made for the past printing and, therefore, a user does not need to provide his/her labor for or pay attention to the settings of distributed printing and the user can execute appropriate distributed printing without specific knowledge concerning distributed printing. When distributed printing was executed in the past for a same document, for a same user, or with the same settings as those for the current distributed printing, the distributed printing is automatically executed with the past settings as far as no problem is particularly arisen with the settings made for the past distributed printing.

1. A distributed printing controlling system configured to connect a plurality of printing apparatuses through a network, to receive data transmitted from an information processing apparatus of a client, and to cause the plurality of printing apparatuses to distributed-print, the system comprising:
a storage unit that stores history information on distributed printing; and
a controlling unit that extracts distributed printing information based on the history information, and sets and controls the distributed printing.

2. The distributed printing controlling system as defined in claim 1, wherein the history information is history information for each document.

3. The distributed printing controlling system as defined in claim 1, wherein the history information is history information for each user.

4. The distributed printing controlling system as defined in claim 1, wherein the history information is history information on printing settings.

5. The distributed printing controlling system as defined in claim 1, wherein the distributed printing information is information on distribution destination printers.

6. The distributed printing controlling system as defined in claim 1, wherein the distributed printing information is information on printing settings.

7. The distributed printing controlling system as defined in claim 1, wherein the distributed printing information that is extracted is displayed.

8. The distributed printing controlling system as defined in claim 1, wherein the distributed printing settings that are extracted are automatically set.

9. The distributed printing controlling system as defined in claim 1, wherein the result of character printing of the plurality of printing apparatuses is stored as the history information with history indicating success or failure inputted.

10. The distributed printing controlling system as defined in claim 1, wherein distributed printing is executed only by the information processing apparatus of the client not through an information processing apparatus of a printing server.

11. A distributed printing controlling method of connecting a plurality of printing apparatuses through a network, receiving data transmitted from an information processing apparatus of a client, and causing the plurality of printing apparatuses to distributed-print, wherein distributed printing information is extracted based on history information on distributed printing and, thereby, distributed printing is executed.

12. A program to cause a computer to execute the distributed printing controlling method as defined in claim 11.
